(19) United States
(12) Patent Application Publication
(10) Pub. No.: US 2025/0045436 A1
(43) Pub. Date: Feb. 6, 2025

(54) MULTI-DOMAIN ONBOARDING OF DATA PROCESSING SYSTEMS

(71) Applicant: Dell Products L.P., Round Rock, TX (US)

(72) Inventors: BRADLEY K. GOODMAN, Nashua, NH (US); JOSEPH CAISSE, Burlington, MA (US); JEROME A. KORTHALS, Round Rock, TX (US); JENNA TARTAGLINO, Needham, MA (US)

(21) Appl. No.: 18/362,906

(22) Filed: Jul. 31, 2023

(51) Int. Cl. G06F 21/62

(52) U.S. Cl. CPC G06F 21/6218

(57) ABSTRACT

Methods and systems for managing vouchers are disclosed. Vouchers may be usable by orchestrators to onboard data processing systems as they are added to a distributed environment. Different orchestrators may be responsible for onboarding data processing systems assigned to different domains. A user associated with a large number of data processing systems may delegate authority to each of the orchestrators. Each orchestrator may then utilize the delegation of authority to obtain vouchers associated with every data processing system in the distributed environment. By doing so, data processing systems may be dynamically assigned and re-assigned to different domains and may be efficiently onboarded by any orchestrator.

### FIELD

Embodiments disclosed herein relate generally to onboarding data processing systems. More particularly, embodiments disclosed herein relate to systems and methods to efficiently onboard data processing systems across multiple domains.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a diagram of a voucher management service facilitating delegation of authority to a first orchestrator in accordance with an embodiment.

FIG. 2B shows a diagram of a voucher management service providing vouchers to two or more orchestrators in accordance with an embodiment.

FIG. 3 shows a flow diagram illustrating a method of providing vouchers to two or more orchestrators in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing performance of computer-implemented services. The computer-implemented services may be performed by any number of data processing systems throughout a distributed environment. Performance of the computer-implemented services may be managed and/or facilitated by one or more entities in a distributed environment, such as an orchestrator, a user device and/or any other data processing system (e.g., device).

Data processing systems added to the distributed environment may be onboarded prior to participating in the provision of the computer-implemented services. Onboarding data processing systems may require verification (e.g., using access credentials, etc.) that an entity has authority over the data processing systems.

However, due to the highly distributed nature of some environments, verifying the identity of the user (and, therefore, the user's permissions) upon each instance of onboarding a new data processing system may be time consuming, inefficient, and may ultimately lead to disruptions to the computer-implemented services.

For example, the user may be prompted to provide access credentials (e.g., a password, etc.) to a voucher management service following each purchase of a data processing system. The voucher management service may provide a voucher to the user in response, the voucher being usable to gain authority over the data processing system. The user may, however, purchase a large number of data processing systems over time and may not have adequate resources (e.g., availability, etc.) to provide the access credentials timely upon each purchase. Consequently, computer-implemented services expected to be provided by the new data processing systems may be delayed until the user has adequate resources to provide the access credentials.

To reduce the impact of onboarding data processing systems on the provision of the computer-implemented services in a highly distributed environment, authority may be delegated to another entity (e.g., other than a device operated by the user) to onboard data processing systems as they are added to the distributed environment. By doing so, the entity (e.g., an orchestrator) may efficiently onboard data processing systems without an interaction with the user.

To do so, the voucher management service may provide a voucher directly to the orchestrator instead of the user. To provide the voucher to the orchestrator without user intervention, the voucher management service may obtain a trusted token from the orchestrator. Following receipt of the trusted token, the voucher management service may validate the trusted token and provide the voucher to the orchestrator.

The trusted token may serve as a means of demonstrating that authority has been designated to the orchestrator by the user to onboard data processing systems purchased by the user. The trusted token may be previously generated through an interaction between the voucher management service and the user and subsequently provided by the user to the orchestrator. The interaction may include the following actions by the voucher management service: (i) obtaining the access credentials from the user, (ii) validating the access credentials, (iii) generating the trusted token, and/or (iv) providing the trusted token to the user.

While described herein with respect to trusted tokens, it may be appreciated that any other cryptographically secure information usable to verify a delegation of authority from the user may be utilized.

To more efficiently manage the large number of data processing systems associated with the distributed environment, the data processing systems may be assigned to different domains. Each domain of the domains may be managed by a different orchestrator. After purchase or otherwise acquisition of a data processing system by the user, the data processing system may be assigned to a domain. In a first example, the user may purchase a data processing system and may not immediately assign a domain to the data processing system (e.g., due to another entity being responsible for this task, etc.).

In a second example, the user may initially assign the data processing system to a first domain and may later wish to re-assign the data processing system to a second domain of the domains. Re-assignment of data processing systems to different domains may occur for any reason including, for example, re-allocation of computational resources to accommodate changes to the computer-implemented services, etc.

To facilitate multi-domain onboarding of data processing systems (e.g., assignment and/or re-assignment of data processing systems across multiple domains), each orchestrator may obtain all vouchers (for all data processing systems owned by the user regardless of domain assignments) prior to performing onboarding processes for data processing systems assigned to a particular domain. By doing so, orchestrators may have flexibility to onboard data processing systems that are dynamically assigned across multiple domains over time. Consequently, computer-implemented services provided by the data processing systems may be less likely to experience interruptions, delays, and/or other issues.

In an embodiment, a method of managing vouchers is provided. The method may include: obtaining at least one request for at least two vouchers to onboard a data processing system to any of at least two orchestrators; making a determination regarding whether the at least one request is a valid request; in a first instance of the determination in which the request is the valid request: obtaining the at least two vouchers; and deploying the at least two vouchers to the at least two orchestrators.

A first voucher of the at least two vouchers may include: a first chain of certificates that delegates authority over the data processing system to a first of the at least two orchestrators.

A second voucher of the at least two vouchers may include: a second chain of certificates that delegates authority over the data processing system to a second of the at least two orchestrators.

The at least one request may include: a first request obtained at a first point in time; and a second request obtained at a second point in time, wherein the first point in time and the second point in time are different points in time.

The first request may indicate that a customer initially desired for the data processing system to join a first domain managed by a first orchestrator of the at least two orchestrators.

The second request may indicate that the customer, after sending the first request, desires for the data processing system to dynamically join either the first domain or a second domain managed by a second orchestrator of the at least two orchestrators.

The second request may indicate that the customer, after sending the first request, desires for the data processing system to leave the first domain and join a second domain managed by a second orchestrator of the at least two orchestrators.

The at least two vouchers may be adapted to instruct the data processing system to trust all of the at least two orchestrators.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

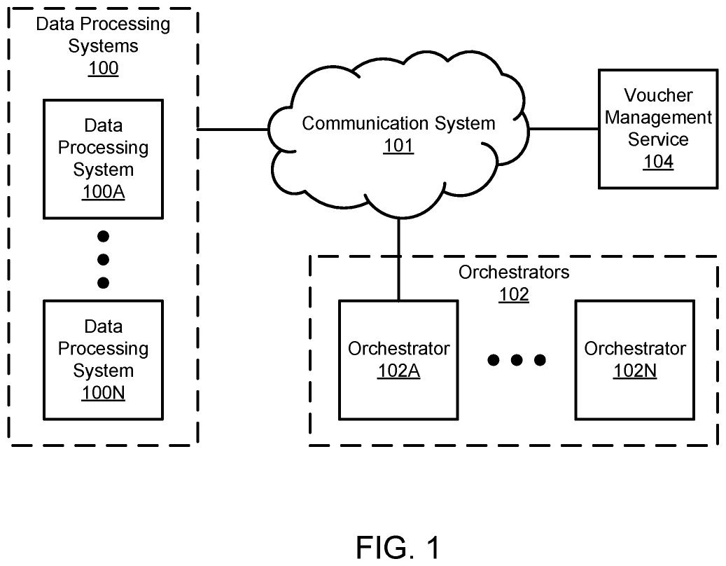

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include data storage services, instant messaging services, database services, and/or any other type of service that may be implemented with a computing device.

To manage performance of the computer-implemented services, a distributed environment may include any number of data processing systems 100. Each data processing system of data processing systems 100 may be onboarded prior to participating in provision of the computer-implemented services. To onboard a data processing system of data processing systems 100 (e.g., data processing system 100A) an entity (e.g., a person/business that owns the data processing system) with authority over data processing systems 100 may obtain a voucher from voucher management service 104.

To obtain the voucher, the entity with authority over data processing systems 100 (e.g., a user) may present access credentials to voucher management service 104. The access credentials may include any authentication factor (e.g., a password, a pin, a biometric factor, etc.) usable to verify the identity and permissions of the user.

However, in a distributed environment that includes a large number of data processing systems 100, the user may not have adequate resources (e.g., hours, computing resource availability, etc.) to provide access credentials prior to each onboarding process for obtaining ownership vouchers for each to-be-onboarded device. Therefore, delays in onboarding data processing systems 100 may lead to reductions in the availability and/or quality of the computer-implemented services to downstream consumers, onboarding of large numbers of devices may place unreasonable cognitive loads on users responsible for managing onboarding, etc.

To onboard data processing systems without user intervention, a trusted token (and/or other means of delegating authority by the user) may be used. The trusted token, for example, may be generated by voucher management service 104 and may be usable to delegate authority to another entity throughout the distributed environment (e.g., an orchestrator of orchestrators 102) to manage onboarding of data processing systems 100.

To generate the trusted token, the user (e.g., via a user device that may be one of data processing systems 100) may present the access credentials to voucher management service 104 and voucher management service 104 may authenticate the access credentials. If the identity of the user is verified using the access credentials, voucher management service 104 may generate the trusted token and may provide the trusted token to the user. The user may then provide the trusted token to an orchestrator of orchestrators 102 (e.g., orchestrator 102A).

The process described above for generating a trusted token and providing the trusted token to an orchestrator of orchestrators 102 may be performed any number of times so that each orchestrator of orchestrators 102 may have a unique trusted token. Each trusted token may be unique due to inclusion of credentials for one orchestrator of orchestrators 102 in the trusted token.

While described above with respect to trusted tokens, it may be appreciated that any type of cryptographically secure information usable to verify a delegation of authority from the user may be implemented.

Therefore, whenever one or more data processing systems is added to the distributed environment, each of orchestrators 102 may provide requests (e.g., each request including a corresponding trusted token) to voucher management service 104. Voucher management service 104 may validate each trusted token and may provide all vouchers (those associated with data processing systems owned by the user) to each of orchestrators 102. Each orchestrator of orchestrators 102 may, therefore, be prepared to onboard any new data processing system that is assigned to the domain over which the orchestrator has authority.

Each orchestrator of orchestrators 102 may be responsible for onboarding data processing systems assigned to a domain of the distributed environment. The distributed environment may be divided up into any number of domains, and each domain of the domains may be associated with a subset of the data processing systems. Each domain may be responsible for different computer-implemented services and/or different portions of the computer-implemented services provided by the distributed environment.

Assignment of data processing systems to domains may occur upon purchase of the data processing systems and/or may occur at a later point in time. Assignments for the data processing systems may also change over time in response to changes to the needs of the user, changes to the needs of a downstream consumer of the computer-implemented services, and/or in response to other events.

For example, a downstream consumer of the computer-implemented services may request different and/or additional computer-implemented services. To accommodate this change, the user may re-assign a data processing system from a first domain managed by a first orchestrator to a second domain managed by a second orchestrator to allocate additional computing resources to a domain responsible for the different and/or additional computer-implemented services requested.

However, the second orchestrator may not have permission to onboard the data processing system to the second domain. Consequently, a delay may occur to accommodate the orchestrator associated with the second domain obtaining permissions (e.g., a voucher) to successfully onboard the data processing system to the second domain. The delay may negatively impact the computer-implemented services expected by the downstream consumer.

In general, embodiments disclosed herein may provide methods, systems, and devices for multi-domain onboarding of data processing systems. Multi-domain onboarding of data processing systems may include allowing orchestrators across multiple domains to maintain vouchers usable to onboard any data processing system that is a member of the distributed environment (e.g., including data processing systems not initially assigned to the domain over which the orchestrator presides). By doing so, data processing systems may be efficiently onboarded by any orchestrator in response to dynamic assignment and re-assignment of the data processing systems to different domains over time.

In a first example, the user may purchase a data processing system and may not immediately assign the data processing system to a domain. To enable the data processing system to be easily assigned to any domain throughout the distributed environment, the user may provide each orchestrator with a unique token and each orchestrator may use their unique token to request all vouchers for all data processing systems owned by the user. Therefore, upon assigning the data processing system to one of the domains, the orchestrator associated with that domain may already have permission to onboard the data processing system.

In a second example, a user may purchase a data processing system and may assign the data processing system to a first domain managed by a first orchestrator. Similarly, each orchestrator may utilize a unique trusted token to obtain all vouchers for all data processing systems owned by the user. The first orchestrator may, therefore, utilize a voucher to onboard the data processing system. Over time, the user may decide to re-allocate computing resources and, therefore, re-assign the data processing system from the first domain to a second domain managed by a second orchestrator. Upon identifying that the data processing system has been assigned to the second domain, the second orchestrator may onboard the data processing system utilizing the previously obtained voucher.

To provide the above noted functionality, the system may include data processing systems 100, orchestrators 102, and voucher management service 104. Each of these components is discussed below.

To provide the computer-implemented services, the system may include any number of data processing systems 100. For example, data processing systems 100 may include one data processing system (e.g., data processing system 100A) or multiple data processing systems (e.g., 100A-100N). Each data processing system of data processing systems 100 may include hardware and/or software components configured to provide the computer-implemented services. Data processing systems 100 may provide various computer-implemented services independently and/or cooperatively.

All, or a portion, of data processing systems 100 may provide (and/or participate in and/or support the) computer-implemented services to various computing devices operably connected to data processing systems 100. Different data processing systems may provide similar and/or different computer-implemented services. For example, data processing system 100A may be a user device used to interact with voucher management service 104 to generate the trusted token. Additionally, data processing system 100N may be a new data processing system requiring onboarding to the distributed environment.

Data processing systems 100 may be manufactured and/or owned by a first party, and provided (e.g., sold) to other parties for use in computer-implemented services. When provided to the other party, a voucher may be used to transfer control over a data processing system to the other party. To facilitate the transfer, each of data processing systems 100 may contact a rendezvous system (not shown) by default. The rendezvous system may direct data processing systems 100 to orchestrators 102 for management.

Voucher management service 104 may provide vouchers (e.g., including information usable to validate a root of trust and delegate authority over a data processing system to another entity) to entities with permissions to onboard and/or manage data processing systems 100. To provide its functionality, voucher management service 104 may: (i) obtain at least one request for at least two vouchers to onboard a data processing system to any of at least two orchestrators, and/or (ii) may determine whether the at least one request is a valid request. If the at least one request is a valid request, voucher management service 104 may: (i) obtain the at least two vouchers, and/or (ii) deploy the at least two vouchers to the at least two orchestrators.

To provide the computer-implemented services, the system may include any number of orchestrators 102. For example, orchestrators 102 may include one orchestrator (e.g., orchestrator 102A) or multiple orchestrators (e.g., 102A-102N). Orchestrators 102 may onboard data processing systems to provide desired computer-implemented services. To onboard data processing systems, each of orchestrators 102 may: (i) obtain a trusted token from the user, (ii) provide the trusted token to voucher management service 104, (iii) obtain all vouchers associated with data processing systems owned by the user in response to providing the trusted token to voucher management service 104, and/or (iv) may utilize the vouchers to onboard and/or further manage any of data processing systems 100.

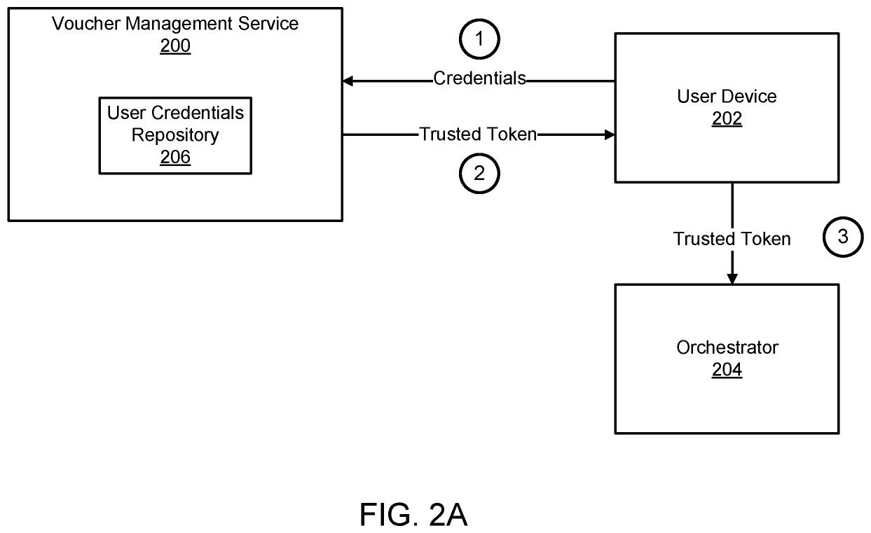

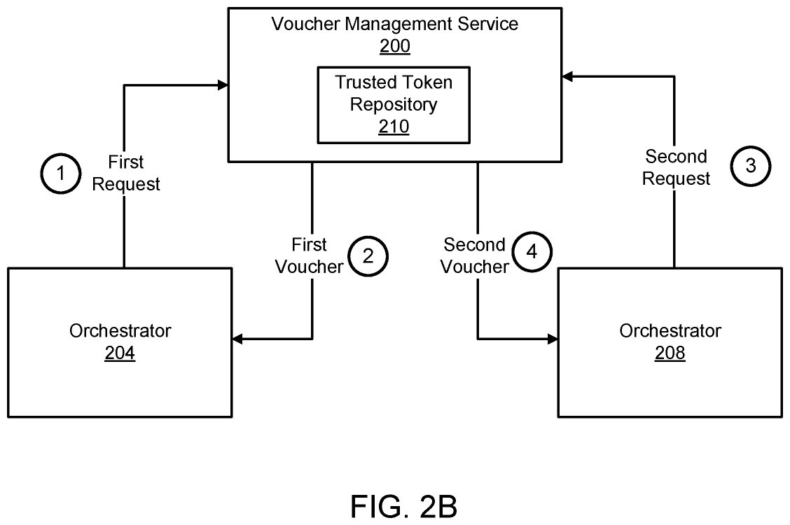

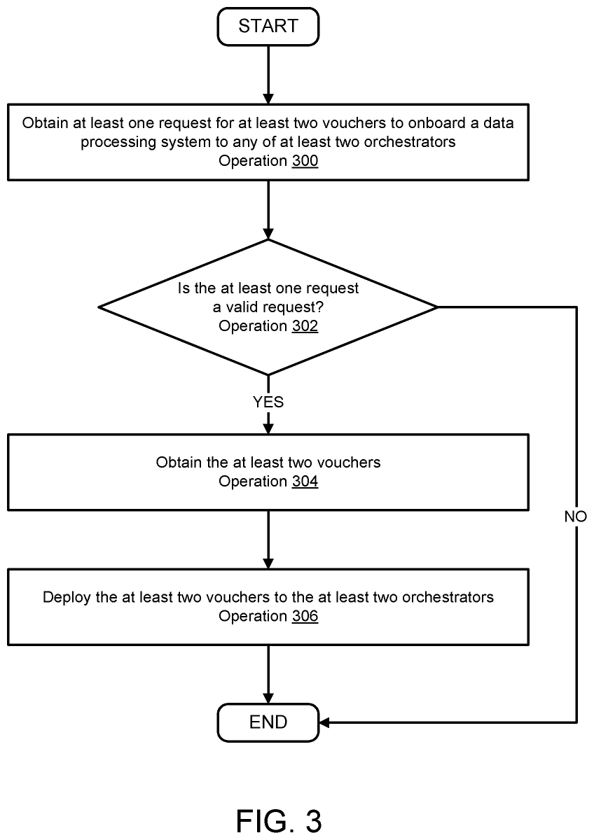

When performing their functionality, data processing systems 100, orchestrators 102, and/or voucher management service 104 may perform all, or a portion, of the methods and/or actions shown in FIGS. 2A-3.

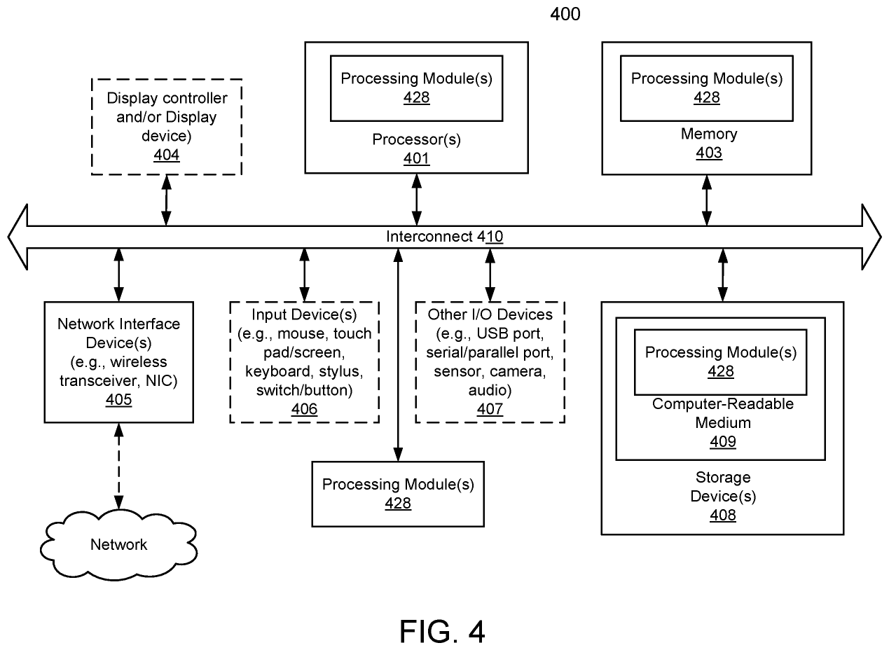

Data processing systems 100, orchestrators 102, and/or voucher management service 104 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

In an embodiment, one or more of data processing systems 100, orchestrators 102, and/or voucher management service 104 are implemented using an internet of things (IoT) device, which may include a computing device. The IoT device may operate in accordance with a communication model and/or management model known to data processing systems 100, orchestrators 102, voucher management service 104, other data processing systems, and/or other devices.

Any of the components illustrated in FIG. 1 may be operably connected to each other (and/or components not illustrated) with a communication system 101. In an embodiment, communication system 101 may include one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

As discussed above, embodiments disclosed herein may facilitate multi-domain onboarding of data processing systems. FIGS. 2A-2B show diagrams illustrating various operations that may be performed to prepare for and/or to onboard data processing systems across multiple domains.

Turning to FIG. 2A, a diagram of a voucher management service facilitating delegation of authority to a first orchestrator in accordance with an embodiment is shown. In FIG. 2A, circles including numbers are used to indicate operations occurring at different points in time. For example, all operations described with reference to number one (1) may occur at a first point in time and all operations described with reference to the number two (2) may occur at a second point in time after the first point in time. While the operations are provided in an example temporal order (e.g., time point one before time point two), it will be appreciated that the operations may be performed in other orders from those illustrated and described herein.

At time point one (1), user device 202 may provide credentials to voucher management service 200. User device 202 may be similar to any of data processing systems 100 shown in FIG. 1 and may be operated by a user with authority over data processing systems throughout a distributed environment (e.g., which may have been purchased from another entity). The credentials may include: (i) access credentials for the user, (ii) credentials for orchestrator 204 (e.g., similar to any of orchestrators 102 shown in FIG. 1), and/or (iii) other information usable to establish authority of the user for management of the data processing system and/or manage onboarding for the data processing system.

The access credentials for the user may include any identifying information usable to authenticate the identity of the user. For example, the access credentials may include a password, pin, biometric factor (e.g., fingerprint, etc.), and/or other information.

The credentials for orchestrator 204 may include any identifier (e.g., an internet protocol (IP) address, a globally unique identifier, etc.) for orchestrator 204. The credentials for orchestrator 204 may be usable by voucher management service 200 to identify an entity throughout the distributed environment. In FIG. 2A, the credentials for orchestrator 204 may indicate to which device user device 202 delegates authority for device onboarding/management purposes.

Voucher management service 200 may obtain the credentials and compare the access credentials (for the user) included in the credentials to corresponding information stored in user credentials repository 206. User credentials repository 206 may include, for example, hashed passwords associated with different users and/or other types of information usable to authenticate the credentials. For example, upon receipt of the credentials, voucher management service 200 may generate a hash of the password included in the credentials and may compare the hash of the password from the credentials to a corresponding hashed password associated with the user (e.g., which may be part of an account with the entity from which data processing systems may be obtained, such as a manufacturer, reseller, etc.). If the hash of the password from the credentials matches the hashed password stored in user credentials repository 206, voucher management service 200 may trust that the credentials originated from the user operating user device 202.

At time point two (2), voucher management service 200 may provide a trusted token (as an example of cryptographically secure information that may be used) to user device 202 in response to the credentials. Voucher management service 200 may generate the trusted token upon verification of the access credentials and/or other information included in the credentials. The trusted token may include: (i) a payload including the credentials for orchestrator 204 (provided in the credentials), and a trusted signature (e.g., cryptographic information generated using a trusted private key (or other type of secret, such as a symmetric key) maintained by voucher management service 200). The trusted signature may, for example, allow voucher management service 200 to determine whether an orchestrator that has the trusted token is an orchestrator for which the trusted token was generated, whether the credentials of orchestrator 204 have been modified since the trusted token was generated, etc.

While described above with respect to trusted tokens, it may be appreciated that delegation of authority by a user to an orchestrator may be facilitated by any means of verifying the identity of the user and providing permission to orchestrator 204.

At time point three (3), user device 202 may provide the trusted token (and/or any other means of delegating authority in a secure manner) to orchestrator 204. By providing the trusted token to orchestrator 204, orchestrator 204 may use the trusted token to indicate its status as an entity trusted by user device 202 (e.g., and, therefore, the user) to onboard and/or further manage data processing systems under the authority of the user. Consequently, when orchestrator 204 provides the trusted token in the future, it may serve to authenticate orchestrator 204 with respect to obtaining vouchers managed by voucher management service 200.

The processes shown in FIG. 2A may be repeated any number of times (e.g., simultaneously or at different times) to provide any number of orchestrators throughout the distributed environment with unique trusted tokens. For example, a second orchestrator (similar to any of orchestrators 102 shown in FIG. 1) may obtain a second trusted token (different from the trusted token shown in FIG. 2A), the second trusted token delegating authority to onboard any data processing system owned by the user to the second orchestrator. By repeating the above-described steps for each orchestrator, each orchestrator may have substantially similar permissions to onboard data processing systems.

Turning to FIG. 2B, a diagram of voucher management service 200 providing vouchers to two or more orchestrators in accordance with an embodiment is shown. In FIG. 2B, circles including numbers are used to indicate operations occurring at different points in time. For example, all operations described with reference to number one (1) may occur at a first point in time and all operations described with reference to the number two (2) may occur at a second point in time after the first point in time. While the operations are provided in temporal order (e.g., time point one before time point two), it will be appreciated that the operations may be performed in other orders from those illustrated and described herein.

Consider a scenario in which orchestrator 204 (e.g., a first orchestrator responsible for a first domain) maintains a first trusted token usable to onboard data processing systems as described in FIG. 2A and orchestrator 208 (e.g., a second orchestrator responsible for a second domain) maintains a second trusted token usable to onboard data processing systems. Orchestrator 204 and orchestrator 208 may utilize the first trusted token and the second trusted token respectively to obtain vouchers usable to onboard any data processing system added to the distributed environment.

To obtain the vouchers, voucher management service 200 may receive at least one request for at least two vouchers to onboard a data processing system to any of the at least two orchestrators. The at least one request may include: (i) a first request obtained at a first point in time and (ii) a second request obtained at a second point in time. The first point in time and the second point in time may be different points in time.

For example, at time point one (1), orchestrator 204 may provide the first request to voucher management service 200. The first request may include: (i) the first trusted token (described in FIG. 2A), (ii) the credentials for orchestrator 204 (described in FIG. 2A), (iii) a public key associated with orchestrator 204, and/or (iv) other information. The first request may indicate that a customer (e.g., the user) initially desired for a to-be-onboarded data processing system (not shown) to join a first domain managed by orchestrator 204.

The public key for the orchestrator (e.g., orchestrator 204) may be a public key (e.g., a string of letters, numbers, other characters, etc.) associated with orchestrator 204 that is available publicly and is usable to verify signatures generated using a private key maintained by orchestrator 204 (e.g., orchestrator 204 may sign work orders for the data processing system using the private key).

Upon receipt of the first request, voucher management service 200 may verify that the first trusted token matches the first trusted token generated by voucher management service 200 (shown in FIG. 2A) and stored in trusted token repository 210. If the first trusted token has not been altered, voucher management service 200 may consider orchestrator 204 as trusted to obtain vouchers for data processing systems under authority of the user.

At time point two (2), voucher management service 200 may provide the first voucher to orchestrator 208 to facilitate onboarding of a data processing system by orchestrator 204. The first voucher may include a first chain of certificates that delegates authority over the data processing system to orchestrator 204. For example, the first voucher may include: (i) verification data usable to validate a root of trust for the data processing system, and (ii) at least one delegation of authority from the root of trust to the public key (e.g., associated with orchestrator 204).

The root of trust may be based on a designated private key and the verification data may include a corresponding public key for the designated private key. The designated private key may be any private key associated with another entity (e.g., a string of numbers and/or letters known kept secret by the other entity) usable for generating signatures. The other entity may be, for example, the manufacturer of the data processing system. The corresponding public key for the designated private key may be any public key (e.g., a string of letters and/or numbers) associated with the manufacturer that is known publicly and is usable to verify signatures generated by the private key.

The at least one delegation of authority from the root of trust to the public key may include a certificate. The certificate may include: (i) a payload including an intermediate public key, (ii) a signature generated using the designated private key, and/or (iii) other information. The at least one delegation of authority may include a certificate chain. The certificate chain may establish cryptographically verifiable delegations of authority from the root of trust to orchestrator 204.

The payload may include a statement of delegation indicating which privileges are being delegated to the entity associated with the intermediate public key. For example, the payload may indicate that all authority to manage, onboard, and/or otherwise modify the data processing system is being delegated to an intermediate entity. The intermediate entity may be, for example, a client that is selling the data processing system to another client. The intermediate public key may be any public key (e.g., a string of letters, numbers, and/or other characters) associated with the intermediate entity that is publicly available and usable for to encrypt data intended to be decrypted by only the intermediate entity. The payload may include any number of such certificates that establish a cryptographically verifiable certificate chain between the root of trust and the public key associated with the designed private key (e.g., managed by orchestrator 204).

The signature generated using the designated private key (e.g., a private key kept secret by the manufacturer of the data processing system) may include cryptographic information generated using the payload and the designated private key. The cryptographic information may include a hash of the information and/or any other type of cryptographic information.

The certificate may also include a second certificate. The second certificate may include: (i) a second payload including the public key for the orchestrator (e.g., orchestrator 204), (ii) a second signature generated using an intermediate private key corresponding to the intermediate public key, and/or (iii) other information.

The second payload may include a second statement of delegation indicating which privileges are being delegated to orchestrator 204. For example, the second payload may indicate that orchestrator 204 is being delegated authority to onboard the data processing system.

The second signature generated using the intermediate private key may include cryptographic information generated using the payload and the intermediate private key (e.g., kept secret by the intermediate entity). The cryptographic information may include a hash of the information and/or any other type of cryptographic information.

While described above with respect to a single voucher (e.g., the first voucher) and a single data processing system (e.g., the to-be-onboarded data processing system), it may be appreciated that any number of vouchers associated with any number of data processing systems owned by the user may be obtained by orchestrator 204 following the same steps as those described above.

At time point three (3) orchestrator 208 may provide a second request to voucher management service 200. The second request may include: (i) a second trusted token, (ii) credentials for orchestrator 208, (iii) a public key associated with orchestrator 208, and/or (iv) other information. The second request may indicate that a customer (e.g., the user), after sending the first request (e.g., at time point one), may desire for the to-be-onboarded data processing system to dynamically join either the first domain or a second domain managed by orchestrator 208.

If the user intends for the data processing system to dynamically join either the first domain or the second domain, the user may instruct orchestrator 204 and orchestrator 208 to obtain (simultaneously or at different points in time as shown in FIG. 2B) vouchers usable to onboard the data processing system. By doing so, both orchestrator 204 and orchestrator 208 may be prepared to onboard the data processing system upon assignment of the data processing system to one of the domains.

Similarly, the second data package may indicate that the customer (e.g., the user), after sending the first request (e.g., at time point one), may desire for the to-be-onboarded data processing system to leave the first domain and join the second domain managed by orchestrator 208.

If the user intends for the data processing system to leave the first domain, the data processing system may be instructed to perform a factory re-set to delete information associated with the first voucher establishing a chain of command to orchestrator 204 and/or the data processing system may establish a new chain of command in response to a second voucher (described below) associated with orchestrator 208 and may retain a copy of the information related to orchestrator 204.

The public key for the orchestrator (e.g., orchestrator 208) may be a public key (e.g., a string of letters, numbers, other characters, etc.) associated with orchestrator 208 that is available publicly and is usable to verify signatures generated using a private key maintained by orchestrator 208 (e.g., orchestrator 208 may sign work orders for the data processing system using the private key).

Upon receipt of the second request, voucher management service 200 may verify that the second trusted token matches the second trusted token generated by voucher management service 200 and stored in trusted token repository 210. If the second trusted token has not been altered, voucher management service 200 may consider orchestrator 208 as trusted to obtain vouchers for data processing systems under authority of the user.

At time point four (4) voucher management service 200 may provide the second voucher to orchestrator 208 to facilitate onboarding of the data processing system by orchestrator 208. The second voucher may include a second chain of certificates that delegates authority over the data processing system to orchestrator 208. For example, the second voucher may include: (i) verification data usable to validate a root of trust for the data processing system, and (ii) at least one delegation of authority from the root of trust to the public key (e.g., associated with orchestrator 208).

The root of trust may be based on a designated private key and the verification data may include a corresponding public key for the designated private key. The designated private key may be any private key associated with another entity (e.g., a string of numbers and/or letters known kept secret by the other entity) usable for generating signatures. The other entity may be, for example, the manufacturer of the data processing system. The corresponding public key for the designated private key may be any public key (e.g., a string of letters and/or numbers) associated with the manufacturer that is known publicly and is usable to verify signatures generated by the private key.

The at least one delegation of authority from the root of trust to the public key may include a certificate. The certificate may include: (i) a payload including an intermediate public key, (ii) a signature generated using the designated private key, and/or (iii) other information. The at least one delegation of authority may include a certificate chain. The certificate chain may establish cryptographically verifiable delegations of authority from the root of trust to orchestrator 208.

The payload may include a statement of delegation indicating which privileges are being delegated to the entity associated with the intermediate public key. For example, the payload may indicate that all authority to manage, onboard, and/or otherwise modify the data processing system is being delegated to an intermediate entity. The intermediate entity may be, for example, a client that is selling the data processing system to another client. The intermediate public key may be any public key (e.g., a string of letters, numbers, and/or other characters) associated with the intermediate entity that is publicly available and usable for to encrypt data intended to be decrypted by only the intermediate entity. The payload may include any number of such certificates that establish a cryptographically verifiable certificate chain between the root of trust and the public key associated with the designed private key (e.g., managed by orchestrator 208).

The signature generated using the designated private key (e.g., a private key kept secret by the manufacturer of the data processing system) may include cryptographic information generated using the payload and the designated private key. The cryptographic information may include a hash of the information and/or any other type of cryptographic information.

The certificate may also include a second certificate. The second certificate may include: (i) a second payload including the public key for the orchestrator (e.g., orchestrator 208), (ii) a second signature generated using an intermediate private key corresponding to the intermediate public key, and/or (iii) other information.

The second payload may include a second statement of delegation indicating which privileges are being delegated to orchestrator 208. For example, the second payload may indicate that orchestrator 208 is being delegated authority to onboard the data processing system.

The second signature generated using the intermediate private key may include cryptographic information generated using the payload and the intermediate private key (e.g., kept secret by the intermediate entity). The cryptographic information may include a hash of the information and/or any other type of cryptographic information.

Following obtaining the first voucher and the second voucher, orchestrator 204 and/or orchestrator 208 respectively may proceed to perform onboarding operations and/or other actions to manage the data processing system (not shown). Therefore, the data processing system may encounter either the first voucher or the second voucher during the onboarding operations. The first voucher and the second voucher may be adapted to instruct the data processing system may trust any of the orchestrators associated with the user (e.g., orchestrator 204, orchestrator 208, and/or any other orchestrator in possession of a valid voucher for the data processing system).

The onboarding operations may include, for example, contacting and providing a copy of the voucher (e.g., the first voucher, the second voucher, and/or any other valid voucher) to a rendezvous system (not shown). The data processing system may contact the rendezvous system by default upon first power up. The data processing system may be directed to an orchestrator initiating the onboarding operations (e.g., orchestrator 204, orchestrator 208, and/or any other orchestrator in possession of a valid voucher for the data processing system) by the rendezvous system and may obtain a copy of the voucher from the rendezvous system or the orchestrator. Consequently, when the data processing system contacts the orchestrator, the data processing system may have access to a trusted key (e.g., from the voucher) usable to cryptographically verify authority of the orchestrator to invoke various functions of the data processing system. For example, to prepare the data processing system to provide certain services, the orchestrator may generate workorders instructing the data processing system to install various pieces of software components, modify configurations of software and/or hardware components, and/or perform other actions.

In an embodiment, the one or more entities performing the operations shown in FIGS. 2A-2B are implemented using a processor adapted to execute computing code stored on a persistent storage that when executed by the processor performs the functionality of the system of FIG. 1 discussed throughout this application. The processor may be a hardware processor including circuitry such as, for example, a central processing unit, a processing core, or a microcontroller. The processor may be other types of hardware devices for processing information without departing from embodiments disclosed herein.

As discussed above, the components of FIG. 1 may perform various methods to manage vouchers. FIG. 3 illustrates methods that may be performed by the components of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of providing vouchers to at least two orchestrators in accordance with an embodiment is shown. The method may be performed, for example, by a voucher management service, an orchestrator, a data processing system, and/or any other entity.

At operation 300, at least one request is obtained for at least two vouchers to onboard a data processing system to any of the at least two orchestrators. The at least one request may include a first request obtained at a first point in time and a second request obtained at a second point in time. The first point in time and the second point in time may be different points in time. Refer to FIG. 2B for additional details regarding obtaining requests for vouchers by orchestrators.

Obtaining the at least one request may include: (i) obtaining the first request at the first point in time, (ii) obtaining the second request at the second point in time, and/or (iii) other methods.

Obtaining the first request may include: (i) receiving the first request in the form of a transmission over a communication system, (ii) reading the first request from storage, and/or (iii) other methods.

Obtaining the second request may include: (i) receiving the second request in the form of a message over a communication system, (ii) reading the second request from storage, and/or (iii) other methods.

At operation 302, it is determined whether the at least one request is a valid request. Determining whether the at least one request is the valid request may include: (i) obtaining information (e.g., a trusted token) from the at least one request, (ii) comparing the information to a copy of the information to determine validity of the information, and/or (iii) determining validity of the at least one request based on the validity of the information, and/or (iv) other methods.

For example, the at least one request may include a first request including a first trusted token. The trusted token included in the first request may be compared to a copy of the first trusted token previously obtained via an interaction with the user. If the first trusted token matches the copy of the first trusted token, the first request may be considered valid. Similarly, the same process may be performed for a second request and/or any additional requests included in the at least one request.

Determining whether the at least one request is the valid request may also include: (i) providing the request to another entity responsible for determining whether the request is the valid request, and/or (ii) other methods.

If the at least one request is a valid request, the method may proceed to operation 304. If the at least one request is not a valid request, the method may end following operation 302.

At operation 304, the at least two vouchers are obtained. Obtaining the at least two vouchers may include: (i) obtaining a first voucher of the at least two vouchers, (ii) obtaining a second voucher of the at least two vouchers, and/or (iii) obtaining any number of additional vouchers of the at least two vouchers.

Obtaining the first voucher may include: (i) generating the first voucher, (ii) reading the first voucher from storage, (iii) receiving the first voucher from another entity, and/or (iv) other methods.

Generating the first voucher may include: (i) obtaining a public key associated with a first orchestrator (e.g., the orchestrator providing the first request) from the request, (ii) encapsulating the public key (and/or other data) in a data structure, (iii) treating the data structure as the first voucher, and/or (iv) other methods.

Obtaining the second voucher may include: (i) generating the second voucher, (ii) reading the second voucher from storage, (iii) receiving the second voucher from another entity, and/or (iv) other methods.

Generating the second voucher may include: (i) obtaining a public key associated with a second orchestrator (e.g., the orchestrator providing the second request) from the request, (ii) encapsulating the public key (and/or other data) in a data structure, (iii) treating the data structure as the second voucher, and/or (iv) other methods.

At operation 306, the at least two vouchers are deployed to the at least two orchestrators. Deploying the at least two vouchers may include: (i) deploying the first voucher, (ii) deploying the second voucher, and/or (iii) deploying any number of additional vouchers associated with the at least two vouchers.

Deploying the first voucher may include: (i) transmitting the first voucher to the first orchestrator (e.g., the orchestrator that provided the first request) in the form of a message over a communications system, (ii) providing the first voucher to another entity and providing the other entity with instructions to provide the first voucher to the first orchestrator, (iii) storing the first voucher in a database and providing the first orchestrator with access credentials to access the database, and/or (iv) other methods.

Deploying the second voucher may include: (i) transmitting the second voucher to the second orchestrator in the form of a message over a communications system, (ii) providing the second voucher to another entity and providing the other entity with instructions to provide the second voucher to the second orchestrator, (iii) storing the second voucher in a database and providing the second orchestrator with access credentials to access the database, and/or (iv) other methods.

The method may end following operation 306.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing vouchers, the method comprising:
obtaining at least one request for at least two vouchers to onboard a data processing system to any of at least two orchestrators;
making a determination regarding whether the at least one request is a valid request;
in a first instance of the determination in which the request is the valid request:
obtaining the at least two vouchers; and
deploying the at least two vouchers to the at least two orchestrators.

2. The method of claim 1, wherein a first voucher of the at least two vouchers comprises:
a first chain of certificates that delegates authority over the data processing system to a first of the at least two orchestrators.

3. The method of claim 2, wherein a second voucher of the at least two vouchers comprises:
a second chain of certificates that delegates authority over the data processing system to a second of the at least two orchestrators.

4. The method of claim 1, wherein the at least one request comprises:
a first request obtained at a first point in time; and
a second request obtained at a second point in time,
wherein the first point in time and the second point in time are different points in time.

5. The method of claim 4, wherein the first request indicates that a customer initially desired for the data processing system to join a first domain managed by a first orchestrator of the at least two orchestrators.

6. The method of claim 5, wherein the second request indicates that the customer, after sending the first request, desires for the data processing system to dynamically join either the first domain or a second domain managed by a second orchestrator of the at least two orchestrators.

7. The method of claim 5, wherein the second request indicates that the customer, after sending the first request, desires for the data processing system to leave the first domain and join a second domain managed by a second orchestrator of the at least two orchestrators.

8. The method of claim 1, wherein the at least two vouchers are adapted to instruct the data processing system to trust all of the at least two orchestrators.

9. A non-transitory machine-readable medium having instructions stored therein, which when executed by a processor, cause the processor to perform operations for managing vouchers, the operations comprising:
obtaining at least one request for at least two vouchers to onboard a data processing system to any of at least two orchestrators;
making a determination regarding whether the at least one request is a valid request;
in a first instance of the determination in which the request is the valid request:
obtaining the at least two vouchers; and
deploying the at least two vouchers to the at least two orchestrators.

10. The non-transitory machine-readable medium of claim 9, wherein a first voucher of the at least two vouchers comprises:
a first chain of certificates that delegates authority over the data processing system to a first of the at least two orchestrators.

11. The non-transitory machine-readable medium of claim 10, wherein a second voucher of the at least two vouchers comprises:
a second chain of certificates that delegates authority over the data processing system to a second of the at least two orchestrators.

12. The non-transitory machine-readable medium of claim 9, wherein the at least one request comprises:
a first request obtained at a first point in time; and
a second request obtained at a second point in time,
wherein the first point in time and the second point in time are different points in time.

13. The non-transitory machine-readable medium of claim 12, wherein the first request indicates that a customer initially desired for the data processing system to join a first domain managed by a first orchestrator of the at least two orchestrators.

14. The non-transitory machine-readable medium of claim 13, wherein the second request indicates that the customer, after sending the first request, desires for the data processing system to dynamically join either the first domain or a second domain managed by a second orchestrator of the at least two orchestrators.

15. A data processing system, comprising:
a processor; and
a memory coupled to the processor to store instructions, which when executed by the processor, cause the processor to perform operations for managing vouchers, the operations comprising:
obtaining at least one request for at least two vouchers to onboard a data processing system to any of at least two orchestrators;
making a determination regarding whether the at least one request is a valid request;
in a first instance of the determination in which the request is the valid request:
obtaining the at least two vouchers; and
deploying the at least two vouchers to the at least two orchestrators.

16. The data processing system of claim 15, wherein a first voucher of the at least two vouchers comprises:
a first chain of certificates that delegates authority over the data processing system to a first of the at least two orchestrators.

17. The data processing system of claim 16, wherein a second voucher of the at least two vouchers comprises:
a second chain of certificates that delegates authority over the data processing system to a second of the at least two orchestrators.

18. The data processing system of claim 15, wherein the at least one request comprises:
a first request obtained at a first point in time; and
a second request obtained at a second point in time,
wherein the first point in time and the second point in time are different points in time.

19. The data processing system of claim 18, wherein the first request indicates that a customer initially desired for the data processing system to join a first domain managed by a first orchestrator of the at least two orchestrators.

20. The data processing system of claim 19, wherein the second request indicates that the customer, after sending the first request, desires for the data processing system to dynamically join either the first domain or a second domain managed by a second orchestrator of the at least two orchestrators.
